(19) United States
(12) Patent Application Publication
(10) Pub. No.: US 2010/0071266 A1
(43) Pub. Date: Mar. 25, 2010

(54) Window operating mechanism

(76) Inventor: Marc-Antoine Archambault, Montreal (CA)

Correspondence Address: GEORGE A. SEABY;SEABY & ASSOCIATES, 250 CITY CENTRE AVNUE, OTTAWA, ON, K1R6K7, CA

(21) Appl. No.: 12/232,840

(22) Filed: Sep. 25, 2008

(51) Int. Cl. E05F 11/02

(52) U.S. Cl. 49/327

(57) ABSTRACT

An operating mechanism which can be used on a right or left opening casement window, includes a crank arm having one end for rotatable connection to one bottom corner of a bottom sash, a row of teeth extending around a major portion of the other end of the crank arm, a worm for rotating the crank arm, and a handle for rotating the worm. By turning the crank arm so that one end of the row of teeth meshes with the worm and connecting the free end of the arm to the appropriate corner of a sash in the open or closed position, the mechanism can be adjusted for a right or left opening window.

### FIELD OF THE INVENTION

This invention relates to a window operating mechanism and in particular to a mechanism for operating a casement window.

### DESCRIPTION OF RELATED ART

As described in the Alain Clavet U.S. Patent Application 2004/0216381, published Nov. 4, 2004, casement windows have become increasingly popular over the past several years. Consequently, there has been a concomitant development of mechanisms for operating such windows. Examples of operating mechanisms for casement windows are described in a fair volume of patent literature such as CA1,301,202, issued to Douglas A. Nolte et al on May 19, 1992, U.S. Pat. No. 2,686,669, issued to R. O. Johnson on Aug. 17, 1954; U.S. Pat. No. 3,044,311, issued to G. W. Gagnon on Jul. 17, 1962; U.S. Pat. No. 4,301,662, issued to F. L. Dusmoor on Nov. 24, 1981; U.S. Pat. No. 4,840,075 issued to D. G. Tucker on Jun. 20, 1989; U.S. Pat. No. 4,938,086, issued to Douglas A. Nolte et al on Jul. 3, 1990; U.S. Pat. No. 6,634,141, issued to Todd A. Anderson et al on Oct. 21, 2003, and U.S. Pat. No. 6,672,010, issued to Steven A. Gledhill et al on Jan. 6, 2004.

Casement windows are constructed to be right or left opening, i.e. hinges are mounted on the left or right side of the window opening. The operating mechanisms provided with such windows are adapted to open a window in one direction only, i.e. right or left opening. In general, the mechanisms include a handle for rotating a worn shaft, which in turn rotates at least one gear and a crank arm to open and close a window. While the elements of the right and left opening mechanisms may be the same, it is necessary to assemble the elements in a different manner to suit the direction of opening. Various attempts have been made to make a universal operating mechanism which can be used to open a window in either direction without changes to the mechanism. Existing mechanisms of this type are somewhat complicated and, as mentioned above, may require different assembly when being installed in a window.

### BRIEF SUMMARY OF THE INVENTION

An object of the present invention is to provide a casement window operating mechanism, which, while being relatively simple, can be used to open a window in either direction.

Another object of the invention is to provide a window operating mechanism which is easily converted from a one arm to a two arm mechanism.

Accordingly, the invention relates to a casement window operating mechanism comprising:

a housing for mounting on the interior of a casement window frame;

a base for mounting in an opening in a casement window, the housing covering a portion of the base extending out of the window frame;

a crank arm having a first end rotatable on the center of said base extending out of an exterior end of said housing for rotatable attachment to a window sash;

a worm rotatable in said housing meshing with said crank arm and adapted to rotate said crank arm in either direction;

teeth on said first end of the crank arm defining a major portion of a circle meshing with said worm, whereby rotation of said gear causes a corresponding rotation of said crank arm to open or close the window in a right or left direction, depending upon which side of the window sash the crank arm is connected.

### BRIEF DESCRIPTION OF THE DRAWINGS

The invention is described hereinafter in greater detail with reference to the accompanying drawings, which illustrate a preferred embodiment of the invention, and wherein:

FIGS. 1 and 2 are isometric views of a casement window operating mechanism in accordance with the invention as viewed from above;

FIG. 3 is an isometric view of the mechanism of FIGS. 1 and 2 as viewed from below;

FIG. 4 is a partly exploded isometric view of the mechanism of FIGS. 1 to 3;

FIGS. 6 and 7 are schematic, isometric views of the bottom portion of a right opening window incorporating the mechanism of FIGS. 1 to 5; and

FIGS. 8 and 9 are schematic, isometric views of the bottom portion of a left opening window incorporating the mechanism of FIGS. 1 to 5.

### DETAILED DESCRIPTION OF THE INVENTION

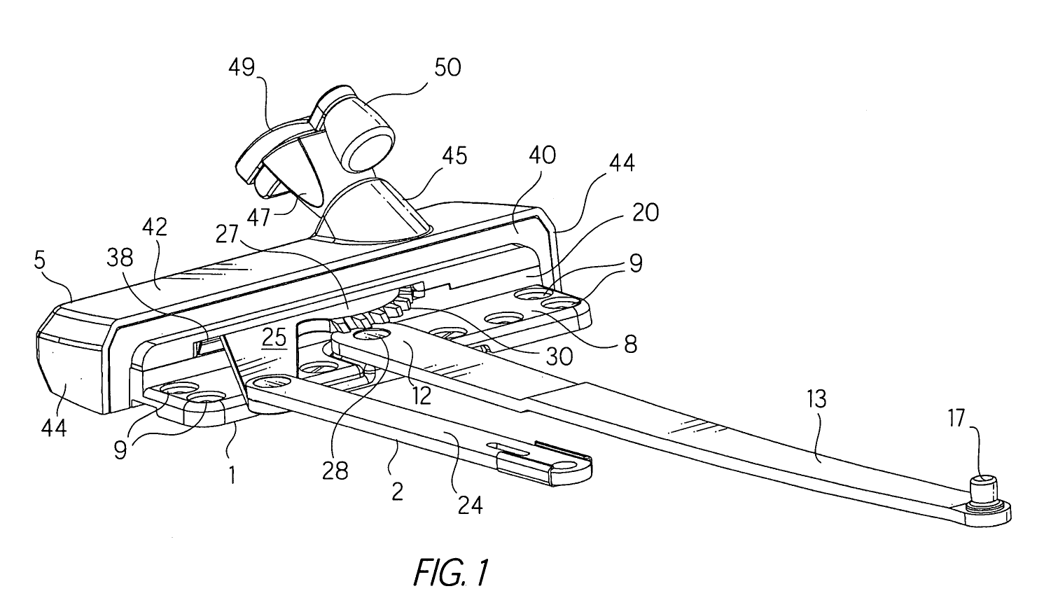

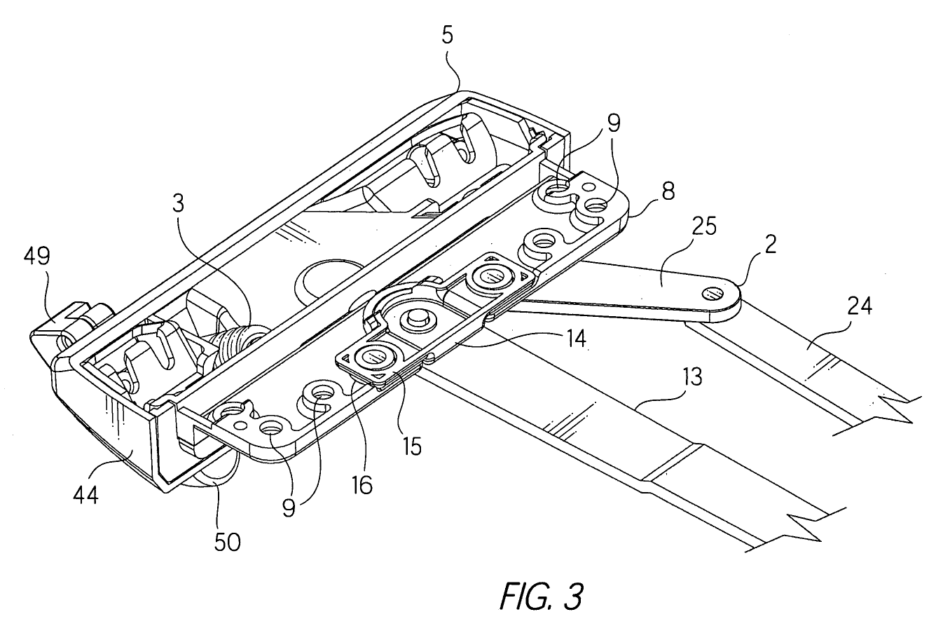

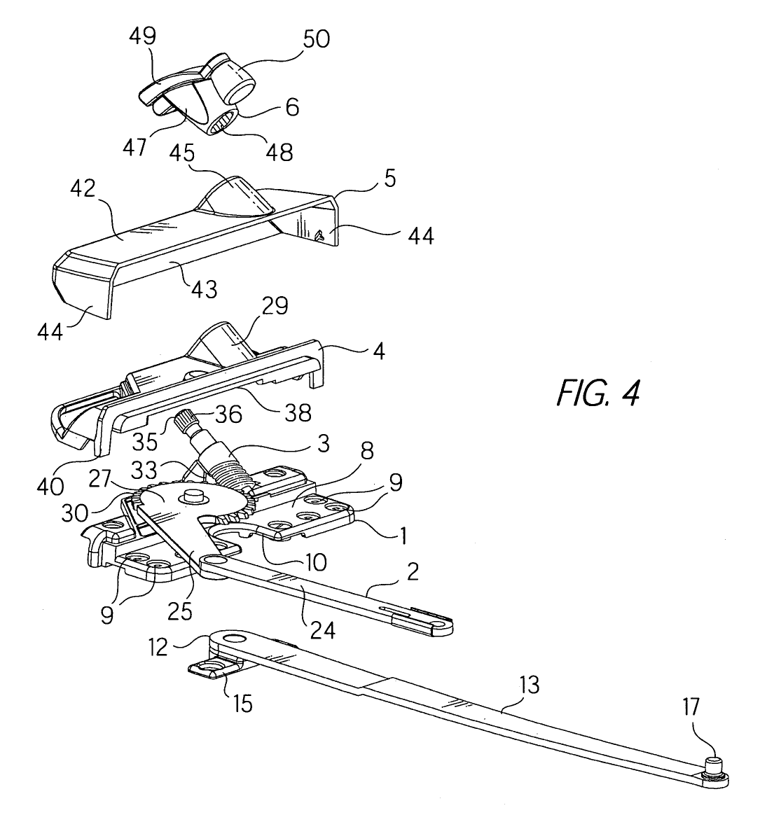

Referring to FIGS. 1 to 4, the basic elements of the window operating mechanism include a base 1, a crank arm 2 rotatably mounted on the base 1, a worm 3 for rotating the crank arm 2, a housing 4 rotatable supporting the worm 3, a cover 5 on the housing 4 and a crank handle assembly 6 for rotating the worm 3.

The base 1 is a one-piece casting including a flat, outer, bottom ledge 8 having a plurality of holes 9 therein for receiving screws (not shown). A large number of holes 9 are provided, because the base 1 is often mounted in a plastic frame which does not hold screws as well as wooden frames. A generally U-shaped notch 10 in the center of the ledge 8 is designed to receive one end 12 of a sliding arm 13 the function of which is described in greater detail below. The end 12 of the arm 13 is pivotably connected to the raised center 14 of a small bar 15 which is mounted in a recess 16 in the bottom center of the ledge 8.

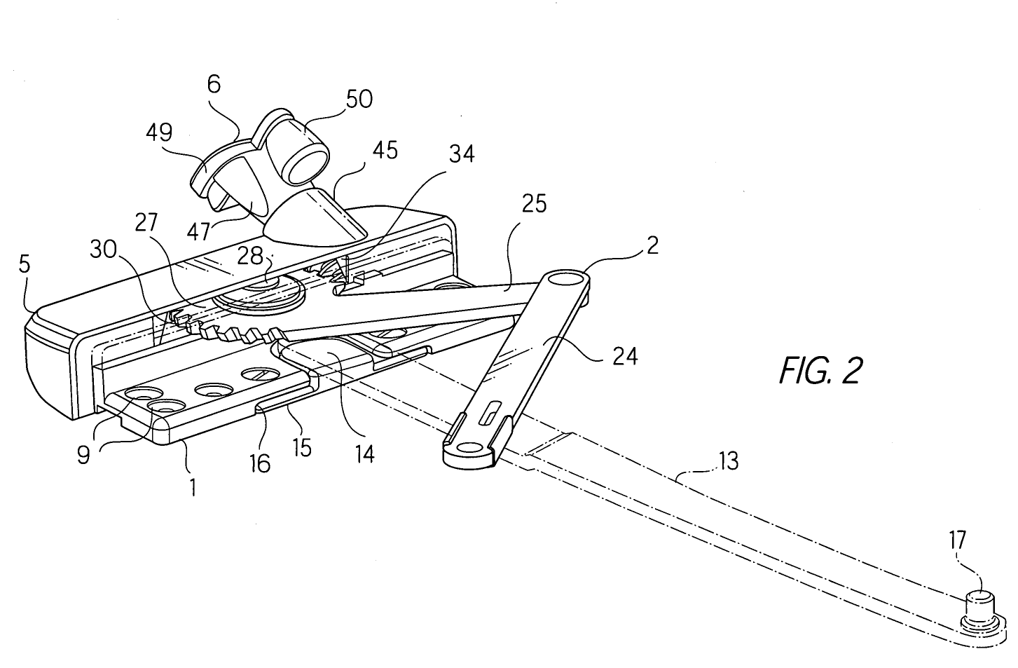

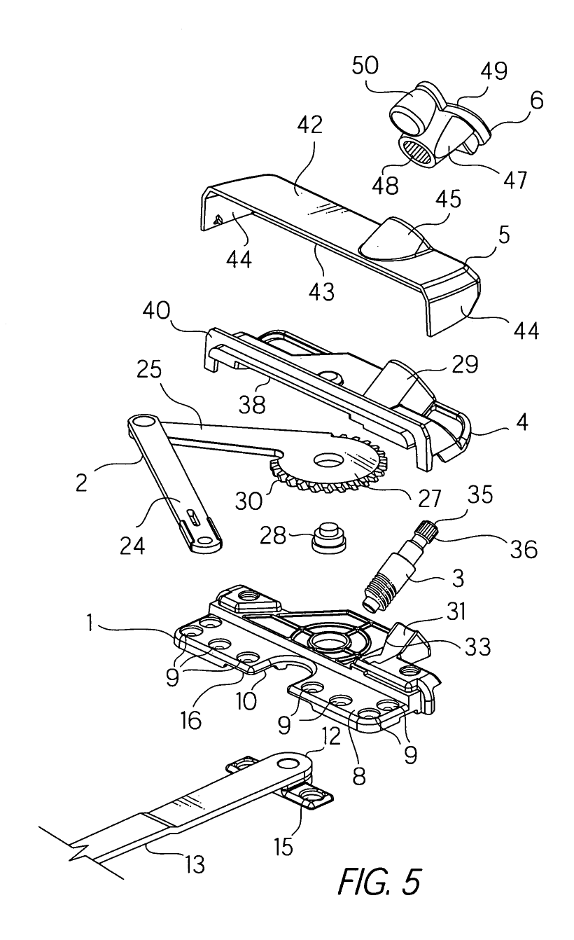

When the bar 15 is mounted in the recess 16, the top of the raised center 14 is in the same plane as the top surface of the ledge 8. In use, a pin 17 on the outer end of the arm 13 slides in a conventional track (not shown) mounted on the bottom of a window sash 18. A shoulder 20 (FIGS. 1 and 2) extends upwardly from the end of the base 1 for limiting movement of the base into an opening (not shown) through the bottom 21 of the window frame 22 (FIGS. 6 to 9) when mounting the mechanism in a window.

The crank arm 2 is defined by pivotally interconnected outer and inner links 24 and 25. The free end of the outer link 24 is pivotally connected to the bottom corner 26 of the window sash 18 on the hinge side of the window. The large circular end 27 of the inner link 25 is rotatably mounted on a pin 28 (FIGS. 1, 2 and 5) in the base 1. Teeth on the end 27 of the crank arm 2 mesh with the included worm 3 so that the crank arm 2 rotates around the axis of the pin 28 when the worm 3 turns. The worm 3 is rotatably mounted on a hub 29 in a housing 4 and extends into a trough 31 on the teeth 30 on the crank arm 2 extend through an opening defined by notches 33 and 34 in the top of the base 1 and the bottom of the housing 4, respectively. The top end 35 of the shaft of the worm 3 includes longitudinally extending spines 36 for connecting the worm to the crank handle 6.

The housing 4 includes a recess 38 in the bottom thereof for accommodating the circular end 27 of the crank arm 2. A fence 40 extends around the sides and top of the inner end of the housing 4. When mounting the mechanism in the window frame 20, the ledge 8 is housed in a socket (not shown) in the window frame. The fence 40 limits movement of the base 1 into the socket, and bears against a vertical surface in the socket to stabilize the mechanism, i.e. to reduce or eliminate torque on the screws holding the base 1 in position during operating of the mechanism.

The cover 5 includes a top wall 42, an end wall 43, side walls 44 and a hole 45 for receiving the hub 29 on the housing 4.

The handle assembly 6 includes a base 47 with a splined socket 48 for mounting on the top end 35 of the worm gear 3 and a handle 49 pivotally connected to the base 47. A knob 50 on the outer free end of the handle 49 facilitates manual manipulating of the handle.

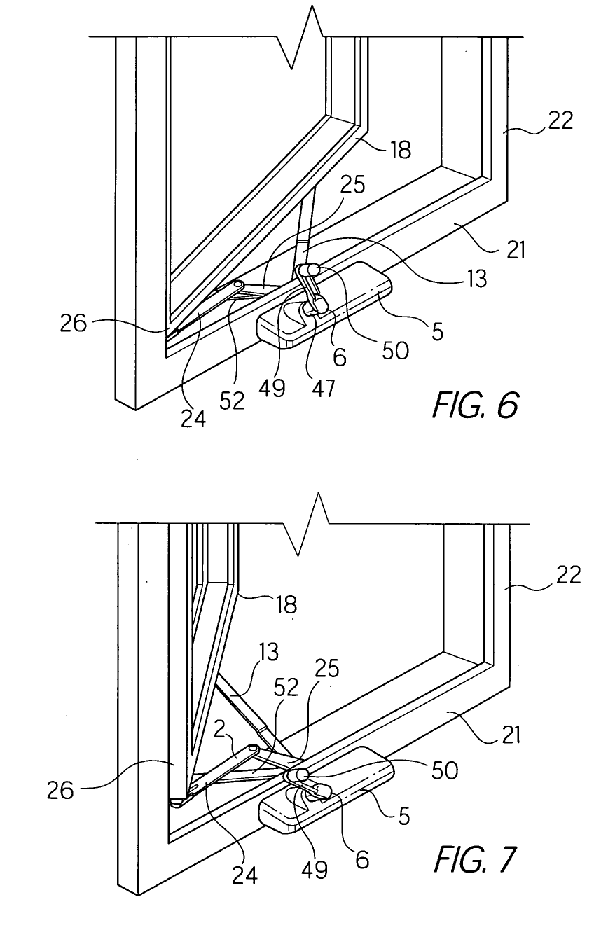

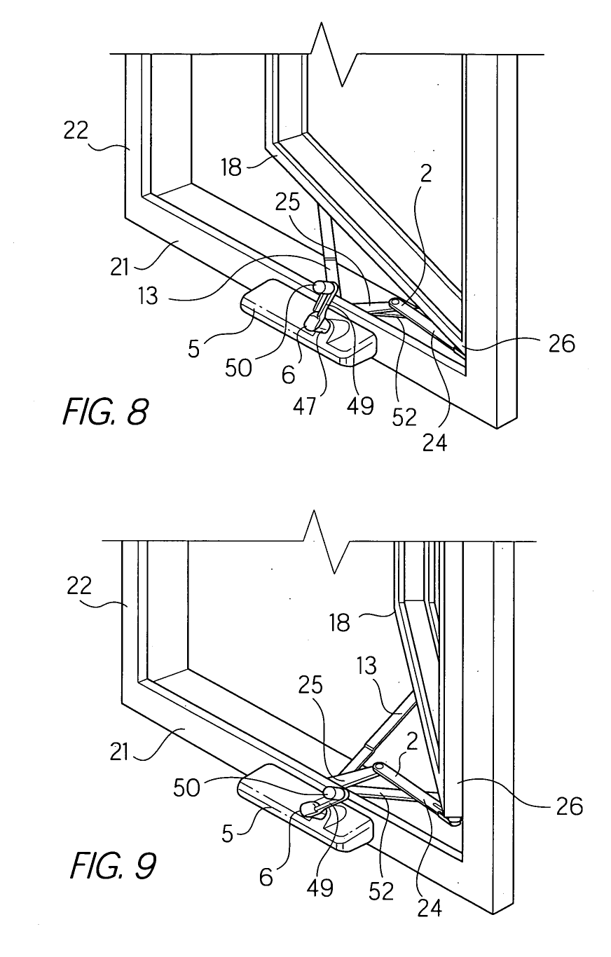

When installing the mechanism in the bottom 21 of a window frame 22, the shoulder 20 on the base 1 and the fence 40 on the housing 4 limit movement of the mechanism into a stepped opening in the frame. The mechanism is installed in either side of the frame 22 depending upon whether the window is right opening (FIGS. 6 and 7) or left opening (FIGS. 8 and 9). For a right opening window, the mechanism is mounted on and in the left side of the window frame 22, and for a left opening window, the mechanism is mounted on and in the right side of the window. The outer end of the crank arm 2 is pivotally connected to the bottom corner of the sash 18. The post 17 is slidably mounted in a conventional track on the bottom of the window. The mechanism is used with a conventional pivot arm 52, which does not form part of the present invention. The ends of the arm 52 are pivotally connected to the window frame 19 and to the bottom fo the sash 18.

As mentioned above, with most conventional window operating mechanisms, it is necessary to provide right and left opening versions, which are identical except that the crank arm for one is the mirror image of the crank arm for the other version. In the case of the present invention, the crank arm 2 is rotated completely to one end of the row of teeth 30 before connecting the crank arm to a window sash 18 in the fully open position. Rotating of the crank arm 2 in the opposite direction will cause the window to move to the closed position. When the mechanism is to be used to open the window in the opposite direction (i.e. left instead of right), the crank arm 2 is rotated completely to the other end of the row of teeth 30 before connecting the arm to the bottom corner of a window sash 18 in the fully open position.

It will be appreciated that the crank arm 2 can be used alone, i.e. without the siding arm 13, particularly with small windows. When the arm 13 is required, it is merely necessary to slide the end 12 of the arm into the notch 10 so that the bar 15 enters the recess 16 and use screws to connect the elements together.

1. A casement window operating mechanism comprising:
a housing for mounting on the interior of a casement window frame;
a base for mounting in an opening in a casement window, the housing covering a portion of the base extending out of the window frame;
a crank arm having a first end rotatable on the center of said base extending out of an exterior end of said housing, and a second end for rotatable attachment to a window sash;
a worm rotatable in said housing meshing with said crank arm and adapted to rotate said crank arm in either direction;
teeth on said first end of the crank arm defining a major portion of a circle meshing with said worm, whereby rotation of said gear causes a corresponding rotation of said crank arm to open or close the window in a right or left direction, depending upon which side of the window sash the crank arm is connected.

2. The window operating mechanism of claim 1 including a sliding arm, and central notch in the outer end of said base for receiving an inner end of the sliding arm.

3. The window operating mechanism of claim 2 including a recess in the bottom center of said outer end of the base for receiving a bar for connecting the sliding arm to the base.

4. The window operating mechanism of claim 2, wherein said crank arm includes an inner link with a circular inner end carrying said teeth for rotatable mounting on said base; and an outer link for pivotally connecting to the inner link the crank arm to a bottom corner of the window sash.
